(19) United States
(12) Patent Application Publication
(10) Pub. No.: US 2012/0200223 A1
(43) Pub. Date: Aug. 9, 2012

(54) Hyperfrequency wave generator device comprising a plurality of magnetrons

(75) Inventors: Jean-Pierre Brasile, Colombes (FR); Dominique Fasse, Colombes (FR); Patrick Sirot, Colombes (FR); Dominique Jousse, Colombes (FR)

(73) Assignee: THALES, Neuilly Sur Seine (FR)

(21) Appl. No.: 13/338,130

(22) Filed: Dec. 27, 2011

(30) Foreign Application Priority Data
Dec. 29, 2010 (FR) 1005161

(51) Int. Cl. H01J 25/50

(52) U.S. Cl. 315/39.61; 315/39.51

(57) ABSTRACT

The hyperfrequency wave generator device according to the invention comprises a plurality of magnetrons, each magnetron comprising: a cathode, and an anode, surrounding the cathode and comprising an inner surface defining a plurality of resonant cavities distributed along its periphery. The generator device also comprises at least one waveguide, each waveguide extending from the anode of a magnetron toward the outside of the magnetron. The plurality of resonant cavities of each magnetron comprises a plurality of resonant connecting cavities, or at least one resonant connecting cavity and at least one resonant output cavity. Each resonant connecting cavity of each magnetron is identical each resonant connecting cavity and, if the magnetron comprises at least one output cavity, to each resonant output cavity of the magnetron.

The present invention relates to a hyperfrequency wave generator device, comprising a plurality of magnetrons, each magnetron comprising:
a cathode, extending along a longitudinal axis, and
an anode, surrounding the cathode and comprising an inner surface defining a plurality of resonant cavities distributed along its periphery, the anode also comprising an outer surface, opposite the inner surface, the generator device also comprising at least one waveguide, the or each waveguide extending from the outer surface of the anode of a magnetron toward the outside of said magnetron, the plurality of resonant cavities of each magnetron comprising a plurality of resonant connecting cavities, or at least one resonant connecting cavity and at least one resonant output cavity, such that:
the or each resonant connecting cavity comprises a connecting portion to a resonant connecting cavity of another magnetron, said connecting portion emerging in the outer surface of the anode,
the or each resonant output cavity comprises an output portion emerging on the outer surface of the anode, opposite a waveguide.

Such hyperfrequency wave generator devices are known and are in particular used in radar systems. The magnetron is a particular hyperfrequency wave generator device for which the cathode is brought to a potential lower than that of the anode, and behaves like an electron source radially emitting electrons toward the anode, in a central space between the cathode and the anode. Under the effect of a longitudinal magnetic field, the emitted electrons begin to rotate transversely between the cathode and anode, which makes it possible to generate the hyperfrequency wave by interaction with the cavities of the magnetron.

It is also known to couple different magnetrons with one another within the same hyperfrequency wave generating device, so as to increase the power extracted from the device. FR 2 462 777 thus describes such hyperfrequency wave generator device.

However, the known devices are not fully satisfactory.

Indeed, the known devices are designed to generate hyperfrequency waves at a predetermined frequency, and it is impossible to change the frequency of the waves generated by a device without causing a phase shift of the magnetrons of said device relative to one another, which causes a chaotic operation of the generator device.

One aim of the invention is therefore to propose a hyperfrequency wave generator device with a very high optimized output, adapted to allow an in-phase extraction over a large number of channels. Another aim of the invention is to be able, within the same generator device, to generate waves over a broad frequency spectrum.

To that end, the invention relates to a hyperfrequency wave generator device of the aforementioned type, characterized in that the or each resonant connecting cavity of each magnetron is identical to the or each other resonant connecting cavity and/or the or each resonant output cavity of said magnetron.

According to specific embodiments of the invention, the generator device according to the invention also comprises one or more of the following features, considered alone or according to all technically possible combinations:

each magnetron comprises a device for adjusting the longitudinal length of each resonant cavity, the longitudinal length being defined between the longitudinal ends of the resonant cavity, the adjustment device comprising at least one mobile element defining a longitudinal end of at least one resonant cavity,

the plurality of resonant cavities of each magnetron comprises a plurality of intermediate resonant cavities inserted between the resonant connecting or output cavities, the number of intermediate resonant cavities inserted between two consecutive resonant connecting or output cavities being equal for each pair of consecutive resonant connecting or output cavities,

the plurality of resonant cavities of each magnetron comprises a plurality of small resonant cavities and a plurality of large resonant cavities, the radial section of each small resonant cavity being smaller than the radial section of each large resonant cavity, the large resonant cavities constituting the resonant connecting and/or output cavities, the small resonant cavities constituting the intermediate resonant cavities,

it comprises a single concentrator to generate a longitudinal magnetic field in each of the magnetrons, the concentrator extending around the set of magnetrons,

the inner surface of the anode of each magnetron defines a plurality of annular connecting surfaces between the primary portion and the connecting or output portion of each connecting or output cavity, each annular connecting surface being curved at all points,

the connecting portion of each resonant connecting cavity is in direct contact with the connecting portion of another resonant connecting cavity,

the anode of each magnetron is invariable per rotation by an angle 2π/n around the longitudinal axis of the cathode of the magnetron, n being an integer,

the anode of each magnetron comprises at least one first portion comprised between the or each connecting cavity and the outer surface, and, if applicable, at least one second portion comprised between the or each resonant output cavity and the outer surface, the or each first portion being identical to the or each other first portion and/or the or each second portion,

the anode of each magnetron comprises at least one first fastening orifice for fastening the magnetron to another magnetron, and, if applicable, at least one second fastening orifice for fastening a connecting flange of a waveguide to the anode, the or each first fastening orifice being identical to the or each other first fastening orifice and/or the or each second fastening orifice.

Other features and advantages will appear upon reading the following description, provided solely as an example and done in reference to the appended drawings, in which:

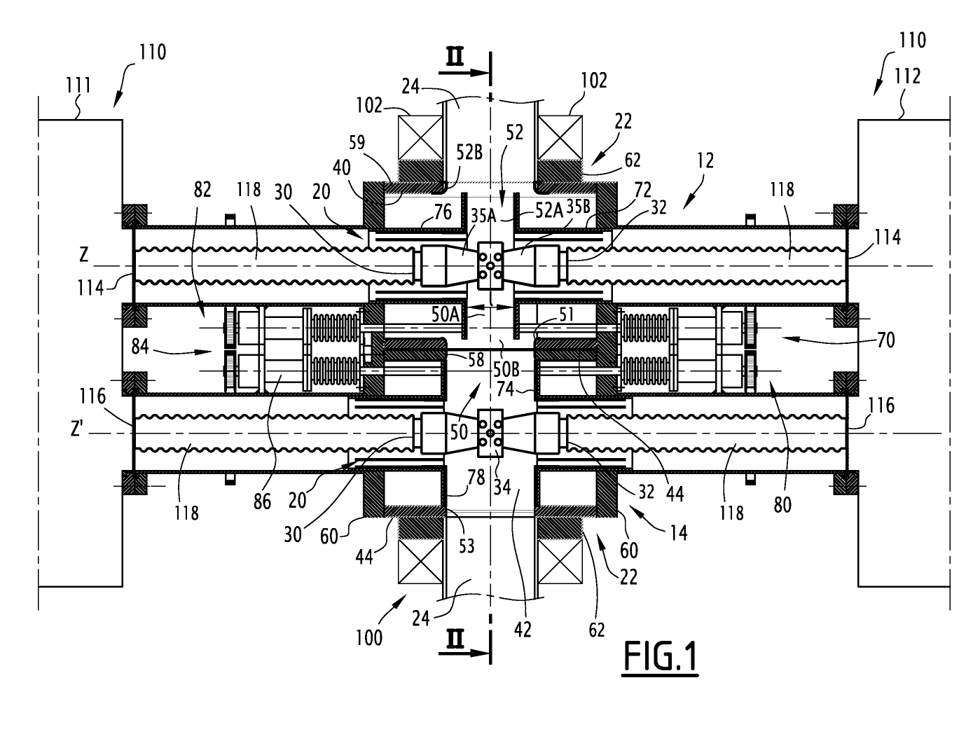

FIG. 1 is a partial cross-sectional view in a longitudinal plane of the generator device according to the invention,

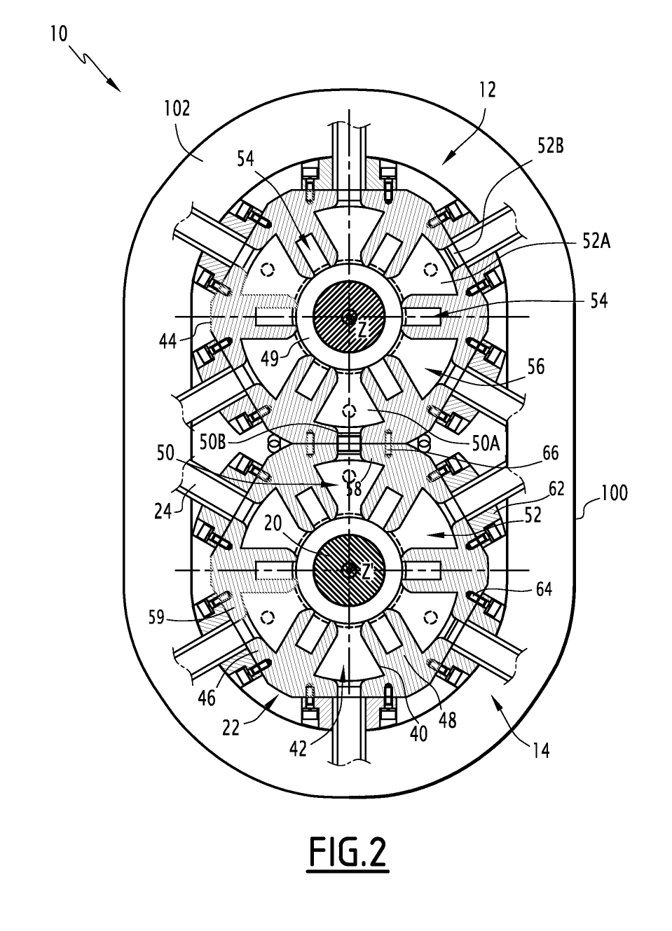

FIG. 2 is a cross-sectional view of the device, along a radial plane marked II-II in FIG. 1,

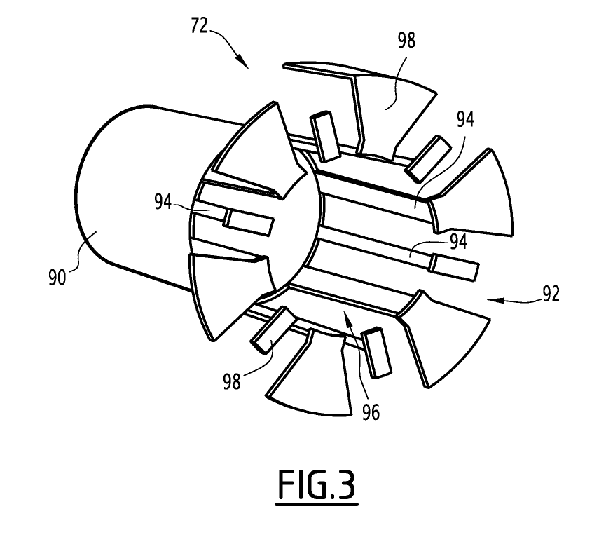

FIG. 3 is a perspective view of an element of a device for adjusting the length of the resonant cavities of the device of FIG. 1,

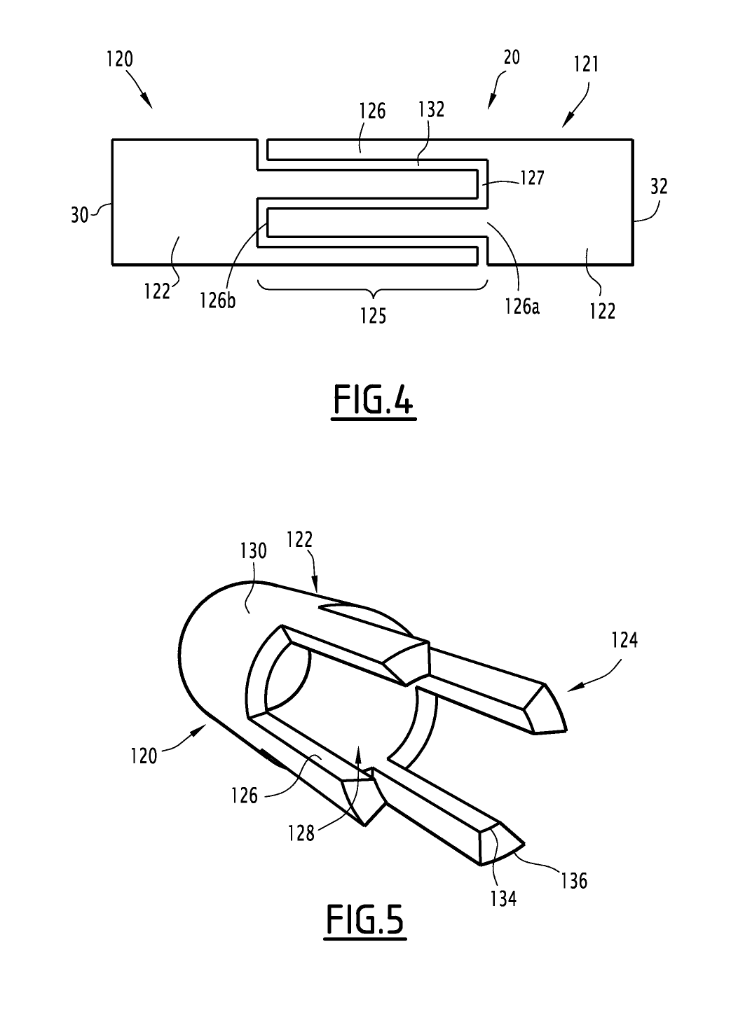

FIG. 4 is a diagrammatic elevation view of a cathode of a generator device, according to one alternative of the invention, and

FIG. 5 is a perspective view of a portion of the cathode of FIG. 4.

As visible in FIG. 1, the device 10 according to the invention comprises two magnetrons 12, 14, positioned substantially parallel to one another and alongside and against one another, and a plurality of waveguides 24.

Each magnetron 12, 14 comprises a cathode 20 and an anode 22 surrounding the cathode 20.

Hereafter, the orientation terms “longitudinal,” “radial” and “transverse” will be used in the following manner:
the cathode 20 of each magnetron 12, 14 is elongated in the longitudinal direction,
the radial direction is oriented from the cathode 20 of each magnetron 12, 14 toward the anode 22 of the magnetron 12, 14, perpendicular to the longitudinal direction, and
the transverse direction is orthogonal to the longitudinal and radial directions and defines, with the radial direction, a radial plane perpendicular to the longitudinal direction.

The cathode 20 of the magnetron 12, respectively of the magnetron 14, extends along a longitudinal axis Z, respectively along a longitudinal axis Z′, from one longitudinal end 30 to a second longitudinal end 32. It is preferably of revolution around the longitudinal axis Z, Z′.

Each cathode 20 comprises an electron source 34 gripped between two tapered fingers 35A, 35B. The electron source 34 is typically equidistant from the longitudinal ends 30, 32 of the cathode 20, formed at the opposite ends of the fingers 35A, 35B.

The electron source 34 is adapted to emit electrons. Typically, the electron source 34 is adapted to emit electrons under the effects of a strong electric field. The electron source 34 is for example a cylinder made from tungsten or, as shown, pyrolytic carbon.

The cathode 20 is at a lower electric potential than the electric potential of the anode 22, such that an electric field exists between the cathode 20 and the anode 22, oriented from the cathode 20 toward the anode 22.

The anode 22 of each magnetron 12, 14 surrounds the cathode 20 of the magnetron 12, 14. The anode 22 extends substantially longitudinally, coaxially with the cathode 20. It has an inner surface 40, oriented toward the cathode 20, defining a plurality of resonant cavities 42 distributed over the periphery of the anode 22, and an outer surface 44, opposite the inner surface 40. The anode 22 is made from a conductive material, typically steel, graphite or copper.

In the illustrated example, the anode 22 is symmetrical relative to a median radial plane, perpendicular to the longitudinal axis Z. In one preferred alternative of the invention, the electron source 34 is, as shown, situated in the median radial plane of the anode 22.

As visible in FIG. 2, the anode 22 comprises a cylindrical body 46 and a plurality of fins 48 extending radially toward the cathode 20. The cylindrical body 46 defines the outer surface 44 and a portion of the inner surface 40. The fins 48 protrude from the cylindrical body 46 toward the inside of the anode 22 and define a portion of the inner surface 40. The fins 48 are identical to one another.

It will be noted that the term “cylindrical” here is to be understood in the broad sense, and covers both cylinders of revolution and cylinders with a square, hexagonal or other section.

Each cavity 42 emerges in a substantially cylindrical central space 49 extending at the center of the anode 22. The central space 49 extends substantially longitudinally. The cathode 20 is positioned substantially at the center of the central space 49.

In the illustrated example, the plurality of resonant cavities 42 of each magnetron 12, 14 comprises a plurality of large resonant cavities 56 and small resonant cavities 54, positioned alternating with one another around the cathode 20. The radial section of each small resonant cavity 54 is smaller than the radial section of each large resonant cavity 56. Preferably, the small 54 and the large 56 resonant cavities all have the same longitudinal length l.

Each large cavity 56 is defined by two fins 48 and the cylindrical body 46. Each small cavity 54 is defined on the inside of a fin 48 by a radial orifice opening opposite the cathode 20. The anode 22 thus has a “rising sun” configuration. This configuration makes it possible to limit the risk of oscillations on disturbance frequencies, and thereby to increase the output of the device 10.

According to one alternative, each large cavity 56 constitutes a resonant connecting 50 or output 52 cavity, and each small cavity 54 constitutes an intermediate resonant cavity. In the illustrated example, each magnetron 12, 14 comprises a single connecting cavity 50 and a plurality of output cavities 52.

The cavities 42 are arranged so that the number of intermediate cavities 54 positioned between two consecutive connecting 50 or output 52 cavities is equal for each pair of consecutive connecting 50 or output 52 cavities.

“Pair of connecting or output cavities” refers to a pair made up of a connecting cavity 50 and an output cavity 52, or two connecting cavities 50, or two output cavities 52.

The connecting cavity 50 comprises a primary portion 50A, defined by the cylindrical body 46 and by two fins 48, and a connecting portion 50B for connecting to the connecting cavity 50 of the other magnetron 12, 14. The connecting portion 50B extends from the primary portion 50A toward the outside of the anode 22, through the cylindrical body 46, and emerges in the outer surface 44. The output portion 50B is made up of a radial orifice formed in the cylindrical body 46 along a radial axis of symmetry of the cavity 50.

The inner surface 40 of the anode 22 defines an annular connecting surface 51 between the primary portion 50A and the connecting portion 50B. Preferably, this annular surface 51 is curved at all points, i.e. it does not have any edges or protrusions, so as to prevent breakdown risks.

In the example illustrated in FIGS. 1 and 2, the connecting portion 50B has a constant transverse section. Alternatively, the connecting portion 50B has a transverse section increasing from the inner surface 40 toward the outer surface 44.

Each connecting portion 50B is symmetrical relative to a median radial plane of the portion 50B. In one preferred alternative of the invention, the median radial plane of the portion 50B is combined with the median radial plane of the anode 22.

The connecting portion 50B of the connecting cavity 50 of each magnetron 12, 14 is in direct contact with the connecting portion 50B of the connecting cavity 50 of the other magnetron 12, 14. In other words, the magnetrons 12, 14 are alongside and against one another so that the outer surface 44 of each anode 22 is in direct contact with the outer surface 44 of the other anode 22, without an element being inserted between the two outer surfaces 44. The connecting surface between the magnetrons 12, 14 is therefore made up of the outer surface 44 of the anode 22 of each magnetron 12, 14.

Each output cavity 52 comprises a primary portion 52A, defined by the cylindrical body 46 and by two fins 48, and an output portion 52B. The output portion 52B extends from the primary portion 52A toward the outside of the anode 22, through the cylindrical body 46, and emerges in the outer surface 44, opposite a waveguide 24. The output portion 52B is formed by a radial orifice formed in the cylindrical body 46 along a radial axis of symmetry of the cavity 52.

The inner surface 40 of the anode 22 defines an annular connecting surface 53 between the primary portion 52A and the output portion 52B. Preferably, this annular surface 53 is curved at all points, i.e. it does not have edges or protrusions, so as to avoid the amplification of disturbance oscillation frequencies.

In the example illustrated in FIGS. 1 and 2, the output portion 52B has a constant transverse section. Alternatively, the output portion 52B has a transverse section increasing from the inner surface 40 toward the outer surface 44.

Each output portion 52B is symmetrical relative to a median radial plane of the portion 52B. In one preferred alternative of the invention, the median radial plane of the output portion 52B of each output cavity 52 is combined with the median radial plane of the output portion 52B of each other output cavity 52, and with the median radial plane of the connecting portion 50B of the connecting cavity 50.

No intermediate cavities 54 emerge in the outer surface 44.

The connecting cavity 50 is identical to each output cavity 52 and, preferably, each intermediate cavity 54 is identical to each other intermediate cavity 54.

The anode 22 comprises a first portion 58 comprised between the connecting cavity 50 and the outer surface 44, and a plurality of second portions 59, each being comprised between an output cavity 52 and the outer surface 44. Each of said first 58 and second 59 portions is made up of a portion of the cylindrical body 46 extending between two consecutive fins 48.

The first portion 58 is identical to each second portion 59. Thus, the behavior of the anode 22 relative to the electrons emitted by the electron source 34 is similar at the connecting cavity 50 and at each output cavity 52.

Alternatively, each magnetron 12, 14 does not comprise any intermediate cavities 54, all of the cavities 42 of the magnetron 12, 14 then being connecting 50 or output 52 cavities.

Returning to FIG. 1, the anode 22 also comprises two longitudinal closing rings 60 of the cavities 42. Each ring 60 thus defines a longitudinal end of the anode 22.

Preferably, the anode 22 of each magnetron, 12, 14 respectively, is invariable per rotation by an angle 2π/n around the longitudinal axis, Z, Z′ respectively, where n is the number of connecting or output cavities 50, 52.

Each waveguide 24 extends from the outer surface 44 of the anode 22 of the magnetron 12, 14 toward the outside of said magnetron 12, 14.

As visible in FIGS. 1 and 2, the anode 22 of each magnetron 12, 14 comprises first orifices 66 for fastening the magnetron 12, 14 to the other magnetron 12, 14. Each first orifice 66 extends substantially radially from the outer surface 44, without emerging in the inner surface 40. Each first orifice 66 is adapted to receive a screw or pin for fastening the magnetrons 12, 14 to one another.

The generator device 10 also comprises connecting flanges 62 for connecting each waveguide 24 to the anode 22 of each magnetron 12, 14. Each flange 62 is adapted to keep one end of a waveguide 24 in contact against the outer surface 44 of an anode 22.

To that end, each anode 22 comprises second fastening orifices 64 of the flanges 62. Each second orifice 64 extends substantially radially from the outer surface 44, without emerging in the inner surface 40. Each second orifice 64 is adapted to receive a screw or pin for fastening the flange 62 to the anode 22.

Each first orifice 66 is identical to each second orifice 64.

As visible in FIG. 1, the generator device 10 also comprises devices 70 for adjusting the longitudinal length l of each resonant cavity 42 of each magnetron 12, 14. The longitudinal length l of each resonant cavity 42 is defined between two longitudinal ends 74, 78 of the cavity 42.

Each adjustment device 70 comprises a first mobile element 72 defining a first longitudinal end 74 of each resonant cavity 42 of the magnetron 12, 14, a second mobile element 76 defining a second longitudinal end 78 of each cavity 42 of said magnetron 12, 14, and longitudinal movement means 80, 82 of each mobile element 72, 76.

Alternatively, each adjustment device 70 comprises a single mobile element 72, 76, a longitudinal end 74, 78 of each cavity 42 then being defined by a ring 60.

The movement means 80, 82 are adapted to move each mobile element 72, 76 so that each resonant output cavity 52 remain symmetrical relative to the median radial plane of its output portion 52B, and so that the connecting cavity 50 remain symmetrical relative to the median radial plane of its connecting portion 50B. Preferably, the movement means 80, 82 are adapted to move each mobile element 72, 76 so that each resonant cavity 42 remains symmetrical relative to the median radial plane of the output portions 52B.

Alternatively, the movement means 80, 82 can be maneuvered independently of one another, for an independent movement of the mobile elements 72, 76.

The longitudinal movement means 80, 82 of each mobile element 72, 76 are typically formed by a plurality of screw-nut systems 84, each screw-nut system 84 comprising a screw 86 rotated and collaborating with a tapping of one of the rings 60 to convert the rotational movement of the screw 86 into a translational movement thereof along the axis Z, Z′. At one end, the screw 86 is secured in translation with the mobile element 72, 76, so that the longitudinal translation of the screw 86 drives the translation of the mobile element 72, 76.

Preferably, the longitudinal movement means 80, 82 each comprise three screw-nut systems 84 distributed over the periphery of the anode 22 of each magnetron 12, 14, around the longitudinal axis Z, Z′, so that the force is distributed homogenously over each mobile element 72, 76.

In one preferred alternative of the invention, the longitudinal movement means 80, 82 also comprise a system (not shown) for jointly rotating the three screws 86, using a belt. Thus, the screw-nut systems 84 are all driven simultaneously, which makes it possible to vary the longitudinal length of each cavity 42 simultaneously.

FIG. 3 shows the mobile element 72. It will be noted that the mobile element 76 is identical to the mobile element 72 and that the description provided below is equally valid for the mobile element 76.

The mobile element 72 comprises a cylindrical base 90, extending longitudinally, and an end collar 92, extending radially outwardly from the base 90. The base 90 and the collar 92 are secured to one another and are preferably made in a single piece.

The base 90 comprises a plurality of longitudinal arms 94 separated by longitudinal slots 96. The arms 94 are adapted to engage in the cavities 42. The slots 96 are adapted to receive the fins 48.

The collar 92 is made up of a plurality of panels 98. Each panel 98 is connected to an arm 94. Each panel 98 has a shape complementary to the radial section of a cavity 42. For each output cavity 52, the associated panel 98 has a shape complementary to the sole primary portion 52A of the cavity 52.

As shown in FIGS. 1 and 2, the generator device 10 also comprises a single concentrator 100, shared by the two magnetrons 12, 14.

The concentrator 100 is adapted to generate a longitudinal magnetic field in each magnetron 12, 14, to cause the electrons emitted by the electron source 34 to rotate. In a known manner, the concentrator 100 comprises, as shown, two Helmholtz coils 102 positioned parallel to one another, each coil 102 extending a radial plane. Specifically, the concentrator 100 extends around the assembly formed by the two magnetrons 12, 14, without a portion of the concentrator 100 extending between the magnetrons 12, 14.

Thus, the generator device 10 is made lighter, and the bulk of the device 10 is reduced.

As shown in FIG. 1, the generator device also comprises a voltage source 110 between the cathode 20 and the anode 22 of each magnetron 12, 14. The voltage source 110 is adapted to establish a negative potential difference between the cathode 20 and the anode 22 of each magnetron 12, 14.

In the illustrated example, each cathode 20 is electrically connected to the voltage source 110 by each of its longitudinal ends 30, 32 so that the electric potential of each end 30, 32 is equal to the electric potential of the other end 30, 32. The voltage source 110 is thus adapted to supply the cathode 20 with current through each of these longitudinal ends 30, 32. Thus, during operation of the generator device 10, the current circulating between the first end 30 and the electron source 34 generates a first transverse magnetic field of the central space 39, between the first end 30 and the electron source 34, while the current circulating between the second end 32 and the electron source 34 generates, in the central space 39, between the second end 32 and the electron source 34, a second transverse magnetic field, in a direction opposite the first transverse magnetic field.

The voltage source 110 is preferably a direct voltage source, so that, during operation, the electric potential of each end 30, 32 of the cathode 20 remains substantially constant. The voltage source 110 is adapted to establish a potential difference V between the cathode 20 and the anode 22 such that:

$$V = \sqrt{\frac{P \times R}{η}}$$

where P is the power of the hyperfrequency wave generated by the device 10, R is the electric impedance of the magnetron 12, and η is the output of the magnetron 12. Typically, the electric impedance of the magnetron is comprised between 45 and 55 ohms, and the output is comprised between 35 and 45%.

The voltage source comprises two branches (not shown) for powering one end of the cathode 20. Each branch extends from the anode 22 to an end 30, 32 of the cathode 20. Preferably, each branch is electrically identical to the other branch, i.e. the electrical characteristics (impedance, inductance) of each branch are similar to the electrical characteristics of the other branch. Thus, during operation, the current circulating in each branch is substantially equal to the current circulating in the other branch, which makes it possible for the transverse magnetic fields to have values substantially equal to one another.

In one preferred alternative of the invention, shown in FIG. 1, the voltage source 110 comprises two voltage generators 111, 112.

Each voltage generator 111, 112 comprises a first electrical connection terminal 114 of a first longitudinal end 30, 32 of the cathode 20 of the first magnetron 12, and a second electrical connection terminal 116 of the longitudinal end 30, 32 of the cathode 20 of the second magnetron 14. These two terminals 114, 116 are at the same electric potential as one another.

Each longitudinal end 30, 32 of the cathode 20 is electrically connected to the terminal 114 of the voltage generator 111, 112 via an elongate conducting pin (not shown) substantially longitudinally, coaxially with the cathode 20. Each conducting pin is insulated from the anode 22 by a layer 118 insulating the conducting pin. Each insulating layer 118 is typically formed from high density polyethylene, or a ceramic.

Each voltage generator 111, 112 is adapted to establish a negative potential difference between the potential of the anodes 22 and the potential of each terminal 114, 116.

Each voltage generator 111, 112 is adapted so that its terminal 114, respectively its terminal 116, is at the same electric potential as the terminal 114, the terminal 116, respectively, of the other voltage generator 111, 112.

In another alternative, the voltage source 110 is formed by a single voltage generator establishing a voltage differential between two terminals, the two longitudinal ends 30, 32 of each cathode 20 being electrically connected to a same first terminal of said two terminals, the anode 22 of each magnetron 12, 14 being electrically connected to the other terminal of said two terminals.

In a third alternative, only one longitudinal end 30, 32 of each cathode 20 is connected to the voltage source 110, the other longitudinal end 30, 32 typically being defined by the electron source 34.

In a fourth alternative, the device 10 comprises a voltage source specific to each magnetron 12, 14. Thus, it is possible to steer the potential of the cathode 20 of the magnetron 12, 14 independently of the cathode 20 of the other magnetron 12, 14. This in particular makes it possible to generate longer wave pulses, by starting a magnetron 12, 14 during the stopped phase of the other magnetron 12, 14. This also makes it possible to accelerate the start-up of one of the two magnetrons 12, 14 by starting it shortly after the other magnetron.

An example of the operation of the device 10 will now be described in reference to FIGS. 1 and 2.

The voltage source 110 establishes a negative potential difference between the anode 22 and the cathode 20. This potential difference generates a radial electric field oriented from the cathode 20 toward the anode 22 and under the effective which the electron source 34 emits electrons.

These electrons, released from the central space 49, are then subjected to the radial electric field and the longitudinal magnetic field. Under the effect of the combination of these two fields, the electrons rotate around themselves and move transversely in the central space 49, between the cathode 20 and the anode 22. This movement of the electrons generates a radiofrequency electromagnetic wave in each magnetron 12, 14. This wave is amplified owing to the resonant cavities 42 and is captured to be used, for example to power a hyperfrequency weapon antenna, owing to the waveguides 24.

Preferably, each magnetron 12, 14 is adapted to amplify a mode π of the radiofrequency wave, i.e. a mode of the wave such that two consecutive resonant cavities 42 oscillate in phase opposition. Due to the rising sun configuration of each magnetron 12, 14, the large cavities 56 thus all oscillate in phase with one another and the small cavities 54 generally all oscillate in phase with one another, each large cavity 56 oscillating in phase opposition with each small cavity 54.

By removing the radiofrequency wave at several output cavities 52, it is possible to extract greater power from the device 10, while preserving a relatively low extracted power per output cavities 52, which makes it possible to limit the breakdown risks at each output cavity 52.

The large cavities 56 making up the output cavities 52 of each magnetron 12, 14, the radiofrequency wave portion captured at each waveguide 24 of each magnetron 12, 14 is thus in phase with the portion of the wave captured at each other waveguide 24 of the magnetron 12, 14. It is thus particularly easy to add the wave portions so as to reconstitute the radiofrequency wave without interference between the different wave portions, and therefore without signal loss.

This makes it possible to increase the output of each magnetron 12, 14.

The fact that the connecting 50 and output 52 cavities of each magnetron 12, 14 are identical to one another also contributes to increasing the output of each magnetron 12, 14.

Furthermore, the connecting cavity 50 of each magnetron 12, 14 being made up of a large cavity 56, it oscillates in phase with each output cavity 52 of the magnetron 12, 14. However, the connecting cavities 50 between the two magnetrons 12, 14 being in direct contact with one another through their connecting portions 50B, without a linking cavity inserted between the connecting cavities, the two connecting cavities 50 oscillate in phase with one another, irrespective of the wavelength of the radiofrequency wave. Thus, irrespective of the wavelength of the radiofrequency wave, each output cavity 52 of each magnetron 12, 14 also oscillates in phase with each output cavity 52 of the other magnetron 12, 14.

This makes it possible to reduce the interference between the wave portions captured at the output cavities 52 of the different magnetrons 12, 14, and thus to increase the output of the device 10.

This also makes it possible to vary the wavelength of the radiofrequency wave generated over a wide range of wavelengths, without decreasing the output of the device 10.

Furthermore, the adjustment devices 70 make it possible to vary the wavelength of the radiofrequency wave, by changing the longitudinal length l of the cavities 42.

Since the adjustment device 70 of each magnetron 12, 14 comprises a single first element 72 to simultaneously move the first longitudinal end 74 of each resonant cavity 42, and a second single element 76 to simultaneously move the second end 78 of each cavity 42, each cavity 42 of the magnetron 12, 14 always has the same longitudinal length as each other cavity 42 of the magnetron 12, 14, which avoids the amplification of disturbance wavelengths that would reduce the output of the magnetron 12, 14.

Furthermore, the movement means 80, 82 being adapted so that each resonant cavity 42 remains symmetrical relative to the median radial plane of the anode 22, the amplitude of the portion of the radiofrequency wave captured at each waveguide 24 is maximal. The output of the device 10 is thus improved.

Lastly, the first and second transverse magnetic fields, in opposite directions, generated by the currents circulating in the cathode 20, make it possible to confine the electrons circulating in the central space 39 near the median radial plane of the anode 22.

It is thus possible to reduce the longitudinal length of the anode 22 and to reduce the intensity of the longitudinal magnetic field. This results in reducing the weight and bulk of each magnetron 12, 14.

Lastly, owing to the combination of the symmetrical electrical power of the cathodes 20 with the adjustment devices 70, it is possible to vary the wavelength of the wave generated by a large value with relatively small movements of the mobile elements 72, 76, and therefore to vary the wavelength of the generated wave over a wide range of wavelengths, while preserving a device 10 with a reduced bulk.

In the alternative illustrated in FIGS. 4 and 5, the cathode 20 comprises two independent portions 120, 121 electrically insulated from one another. A first portion 120 defines the first end 30 of the cathode 20, and the second portion 121 defines the second end 32 of the cathode 20.

Each portion 120, 121 comprises a solid cylindrical end segment 122, and an openwork segment 124. The portions 120, 121 are arranged head-to-tail, and the openwork segments 124 are engaged in one another, so that together they form a central openwork segment 125 of the cathode 20, and each end segment 122 defines a longitudinal end 30, 32 of the cathode 20.

The openwork segment 124 of each portion 120, 121 comprises a plurality of bars 126 extending longitudinally from a longitudinal end of the end segment 122 toward the end segment 122 of the other portion 120, 121. Each bar 126 is linked by a first end 126a with the end segment 122 of the portion 120, 121, the second end 126b of each bar 126 being free. An empty space 127 is formed between the free end 126b of each bar 126 and the end segment 122 of the other portion 120, 121 of the cathode 20.

Each bar 126 extends along the periphery of the anode 20, so that the bars 126 define, together and with the end segments 122, an empty inner chamber 128. Each bar 126 defines a portion of the outer surface 130 of the cathode 20.

A window 132 extends between each consecutive pair of bars 126. Each window 132 emerges in the outer surface 130 and in the inner chamber 128.

The portions 120, 121 are positioned so that their openwork segments 124 are interwoven, i.e. each bar 126 of each pair of consecutive bars is part of a different portion 120, 121 from the portion 120, 121 to which the other bar 126 of said pair of consecutive bars belongs.

As shown in FIG. 5, each bar 126 has a substantially trapezoidal radial section, the small side 134 of the trapezoid being oriented toward the chamber 128 and the large side 136 being oriented toward the outside.

Thus, the two ends 30, 32 of the cathode 20 are electrically insulated from one another, which makes it possible to avoid circulation of electrical current from one end 30, 32 to the other.

Furthermore, the interwoven arrangement of the bars 126 of each portion 120, 121 makes it possible, at a constant longitudinal magnetic field intensity, to increase the potential difference between the cathode 20 and the anode 22, which makes it possible to increase the power of the wave generated by the device 10 while preserving a generator device 10 with a reduced weight and bulk.

Lastly, the two portions 120, 121 together make up a so-called transparent cathode that makes it possible to accelerate the start-up of the generator device 10, in particular by more quickly accessing a stable radiofrequency wave generator state than the traditional cathodes.

In the example described above, there are two magnetrons. However, this number is not limiting, and the invention also targets hyperfrequency wave generator devices comprising any number, greater than or equal to three, of magnetrons. In that case, some magnetrons have a number of resonance connecting cavities greater than or equal to two, and those resonant connecting cavities are then identical to one another.

1-10. (canceled)

11. A hyperfrequency wave generator device, comprising a plurality of magnetrons, each magnetron comprising:
a cathode, extending along a longitudinal axis (Z, Z′); and
an anode, surrounding the cathode and comprising an inner surface defining a plurality of resonant cavities distributed along its periphery, the anode also comprising an outer surface, opposite the inner surface;
the generator device also comprising at least one waveguide, each of the waveguides extending from the outer surface of the anode of a magnetron toward the outside of the magnetron, the plurality of resonant cavities of each magnetron comprising a plurality of resonant connecting cavities, or at least one resonant connecting cavity and at least one resonant output cavity;
each of the resonant connecting cavities comprises a connecting portion to a resonant connecting cavity of another magnetron, the connecting portion emerging in the outer surface of the anode;
each of the resonant output cavities comprises an output portion emerging on the outer surface of the anode, opposite a waveguide;
each resonant connecting cavity of each magnetron is identical to each other resonant connecting cavity and, if the magnetron comprises at least one output cavity, each resonant output cavity of the magnetron.

12. The hyperfrequency wave generator device according to claim 11, each magnetron comprises a device for adjusting the longitudinal length (l) of each resonant cavity, the longitudinal length (l) being defined between the longitudinal ends of the resonant cavity, the adjustment device comprising at least one mobile element defining a longitudinal end of at least one resonant cavity.

13. The hyperfrequency wave generator device according to claim 11, the plurality of resonant cavities of each magnetron comprises a plurality of intermediate resonant cavities inserted between the resonant connecting or output cavities, the number of intermediate resonant cavities inserted between two consecutive resonant connecting or output cavities being equal for each pair of consecutive resonant connecting or output cavities.

14. The hyperfrequency wave generator device according to claim 13, the plurality of resonant cavities of each magnetron comprises a plurality of small resonant cavities and a plurality of large resonant cavities, the radial section of each small resonant cavity being smaller than the radial section of each large resonant cavity, the large resonant cavities constituting the resonant connecting cavities and, if the magnetron comprises at least one output cavity, each output cavity, the small resonant cavities constituting the intermediate resonant cavities.

15. The hyperfrequency wave generator device according to claim 11, comprising a single concentrator to generate a longitudinal magnetic field in each of the magnetrons, the concentrator extending around the set of magnetrons.

16. The hyperfrequency wave generator device according to claim 11, the inner surface of the anode of each magnetron defines a plurality of annular connecting surfaces between the primary portion and the connecting or output portion of each connecting or output cavity, each annular connecting surface being curved at all points.

17. The hyperfrequency wave generator device according to claim 11, the connecting portion of each resonant connecting cavity is in direct contact with the connecting portion of another resonant connecting cavity.

18. The hyperfrequency wave generator device according to claim 11, the anode of each magnetron is invariable per rotation by an angle 2π/n around the longitudinal axis (Z, Z′) of the cathode of the magnetron, n being an integer.

19. The hyperfrequency wave generator device according to claim 11, the anode of each magnetron comprises at least one first portion comprised between each connecting cavity and the outer surface, and, if the magnetron comprises at least one output cavity, at least one second portion comprised between each resonant output cavity and the outer surface, each first portion being identical to each other first portion and, if the magnetron comprises at least one output cavity, to each second portion.

20. The hyperfrequency wave generator device according to claim 11, the anode of each magnetron comprises at least one first fastening orifice for fastening the magnetron to another magnetron, and, if the magnetron comprises at least one output cavity, at least one second fastening orifice for fastening a connecting flange of a waveguide to the anode, each first fastening orifice being identical to each other first fastening orifice and, if the magnetron comprises at least one output cavity, to each second fastening orifice.
